(19) United States
(12) Patent Application Publication
(10) Pub. No.: US 2010/0121661 A1
(43) Pub. Date: May 13, 2010

(54) CHARTERED FLIGHT SWAPPING BUSINESS MODEL

(76) Inventor: Chi Seung Won, Seoul (KR)

Correspondence Address: BUCHANAN, INGERSOLL & ROONEY PC, POST OFFICE BOX 1404, ALEXANDRIA, VA, 22313-1404, US

(21) Appl. No.: 12/594,396

(22) PCT Filed: Aug. 25, 2007
(86) PCT No.: PCT/KR07/04096

§ 371 Date: Oct. 2, 2009

(51) Int. Cl. G06Q 50/00; G06Q 10/00; G06F 15/16

(52) U.S. Cl. 705/5; 709/203

(57) ABSTRACT

The present invention relates to a passenger swapping reservation system and method using a chartered transportation means, and more particularly, to a passenger swapping reservation system and method using a chartered transportation means, wherein a chartered transportation means can be inexpensively and conveniently reserved on-line to meet international flight and/or travel demands without using scheduled routes, such as previously opened flight routes, of traveler transportation means. A passenger swapping reservation system and method using a chartered transportation means of the present invention is a passenger swapping reservation system and method including at least one reservation server connected to a plurality of clients through an on-line network.

### TECHNICAL FIELD

The present invention relates to a passenger swapping reservation system and method using a chartered transportation means, and more particularly, to a passenger swapping reservation system and method using a chartered transportation means, wherein a chartered transportation means can be inexpensively and conveniently reserved on-line to meet international flight and/or travel demands without using scheduled routes, such as previously opened flight routes, of traveler transportation means.

### BACKGROUND ART

In the past, export industry was encouraged in Korea to increase the national income, and everyone recognized the export industry as for manufacturing products such as textile, garments, electric appliances, semiconductors, and the like, or processing half-finished products imported from other countries and selling them to other countries. However, export of intangible tour products, i.e., actively advertising their own culture and contents and selling tour products by attracting foreign tourists, rather than merely selling tangible goods, gradually takes a greater portion of the national income recently in developed countries. In Korea, deficit in tourism grows every year despite expansion in exports. The number of foreign tourists visiting Korea from other countries grows slowly, whereas the amount of money spent by Korean tourists during tours abroad is greatly increased, and thus an adverse balance in tour industry is getting seriously worsened. Although the central government, local governments, and private companies introduce a variety of promotions in order to solve the problems of Korean tourism, their effects are not remarkable yet. In order to attract tourists to Korea from other countries and increase tourism revenue, development of a variety of tour products is needed above all. Development of tour courses introducing Korean traditional culture, foods, and history and development of a variety of leisure facilities, accommodations, and amenities will be needed, together with development of a variety of tour products combining the tour courses and facilities, e.g., tour products introducing mysterious oriental culture, foods, and history. For example, development of an oriental package tour product connecting east-north three countries of Korea, China, and Japan may be considered to attract interests of Western tourists.

On the other hand, although people in Korea desire to take a trip to America or Europe once, tour expenses are too high in comparison with tours in Asian countries, and at least 15 days are required for the trip to America or Europe. Therefore, company employees may have a trip to Western countries only during summer holidays, New Year's holidays, or Chuseok holidays. However, the summer holidays, New Year's holidays, or Chuseok holidays are known as so-called “hot days”, i.e., a high travel season in tour industry, and it is extremely difficult to get an airplane ticket to America or Europe. Accordingly, although there are demands in Western countries on oriental tour products for visiting the mysterious Orient, which connect Korea, China, and Japan, and demands in Korea on tour products for visiting Europe during the so-called “hot days”, in addition to flight demands accompanied with the tour products, there is not at all a system and method for reserving passenger transportation means, which efficiently and inexpensively combines a flight product and/or a travel product to meet such demands.

In airplane reservation systems developed up to date, airline companies take reservations using an airplane ticket sales network for scheduled airplane routes previously opened by the airline companies, and airplane users should make a reservation for a route that passes through a specific region in order to purchase an inexpensive airplane ticket. However, although a flight purchased in such a reservation method is inexpensive, it is inconvenient in that a user should change airplanes. Furthermore, when a direct air route to a region desired by airplane users is not opened due to imbalanced income or the like of the airline companies, the airplane users should inevitably use only an inconvenient via route instead of a direct air route. Therefore, the airplane routes previously opened by the airplane companies are limited in their reservation and operation. Furthermore, when an international conference or event of a large scale is held in a foreign country, there may be a special case where existing flights cannot meet the flight demand. At this time, a company that organizes the international conference or event charters an airplane and carries passengers, and the chartered airplane that has flied to the foreign country only has to return to Korea without filling in empty seats. Accordingly, considering high rental cost of the chartered airplane, the risk of the company that organizes the event is high, and airplane fares of the passengers will be increased.

Therefore, in the art to which the invention pertains, a passenger reservation system and an operation method for efficiently and inexpensively combining flight products and/or travel products have been earnestly requested to meet international flight and/or travel demands. In addition, since existing airplane routes are limited in their reservation and operation, a passenger reservation system and an operation method for inexpensively opening a direct air route of a chartered airplane and taking reservation for the airplane even when a direct air route to a region desired by airplane users is not opened have been earnestly requested. Furthermore, a method for efficiently using an airplane chartered for a variety of large-scaled events needs to be reconsidered.

On the other hand, Korean Laid-open Patent Publication No. 1999-78636 discloses a system for automatically configuring a travel package, in which a traveler may configure a travel package of his or her own by himself or herself, estimate a required budget, and make a reservation for the package. However, the system only discloses information for helping the traveler to determine whether to make a reservation by merely informing him or her of cost when the traveler designs a trip based on his or her taste and budget. Accordingly, the prior art is not a method for conveniently and inexpensively securing a reservation for a flight on so-called “hot days”, where it is hard to make a reservation for a flight and a tour product, to meet flight and travel demands. In addition, although Korean Laid-open Patent Publication No. 2002-11543 discloses a method and system for providing real-time customer-tailored travel information, in which a person who is planning a trip may be provided with a travel schedule suitably designed to his or her travel plan, the document merely discloses a method and system for designing a trip and purchasing a customer-tailored tour product on-line based on the traveler's taste. Therefore, the prior art does not also provide a method for conveniently and inexpensively securing a reservation for a flight to flexibly meet flight and travel demands.

### DISCLOSURE OF INVENTION

### Technical Problem

The present invention is conceived to solve the aforementioned problems. An object of the present invention is to provide a system and method for reserving a passenger transportation means, in which flight products and/or travel products are efficiently and inexpensively combined to meet international flight and/or travel demands.

Another object of the present invention is to provide a system and method for reserving a passenger transportation means, in which limitation in reserving and operating flight routes previously opened by airline companies can be overcome, a direct air route is easily and inexpensively opened to flexibly meet flight demands, and travelers may make a reservation for the route.

A further object of the present invention is to provide a system and method for reserving a passenger transportation means, in which chartered international airplanes can be efficiently used for a variety of large-scaled international activities or events.

### Technical Solution

According to the present invention for achieving the aforementioned objects, a passenger swapping reservation system and method using a chartered passenger transportation means, such as a chartered airplane, is implemented on-line. The concept of swapping passengers using an international chartered airplane employed in the present invention will be described below.

For example, an oriental tour package for visiting three east-north Asian countries connecting Korea, China, and Japan for 15 days, which combines tour courses introducing histories and cultures of the countries and unique tour products thereof, is introduced in Europe, and tourists who desire to take a trip to Europe during a high travel season (e.g., New Year's or Chuseok holidays), which is a season when an airplane ticket is most difficult to obtain, are gathered in Korea. In Europe, it is advertised that the oriental tour package provides a chance of a lower price for experiencing the three east-north Asian countries connecting Korea, China, and Japan in the far east, which were regarded as far and mysterious until now, and a tour group of the “oriental tour package” is made up of persons as many as the number of seats of a chartered airplane (e.g., 300 persons). In Korea, a tour group of 300 persons, which is as many as the number of seats of the chartered airplane, for experiencing European culture during a high travel season at a lower price is made up. Then, an appropriate date among New Year's or Chuseok holidays of a high travel season in Korea is determined as the departure date of the chartered airplane. If a European country where an appropriate number of tourists are gathered as a tour group of the oriental tour package is, for example, Germany, the destination of the airplane chartered for the Korean tour group visiting Europe is determined as Frankfurt in Germany. If the arrival date of the chartered airplane at Frankfurt in Germany is determined as the departure date of the oriental package tour group of Germany starting for an east-north three country experience tour, when the chartered airplane that has flied from Incheon in Korea to Frankfurt in Germany returns to Korea, the chartered airplane does not return to Korea with empty seats, but returns carrying the oriental package tour group (e.g., 300 tourists equal to the number of seats of the chartered airplane). That is, the number of passengers can be doubled in maximum at the same rental cost of the chartered airplane by exquisitely swapping passengers of the Korean tour group to Europe with passengers of the oriental package tour group of Germany using the chartered airplane, and thus an airplane fare may be lowered as much as a half in maximum. Particularly, if the chartered flight swapping business model is implemented as a chartered airplane reservation system on-line, convenience of airplane users and tour product purchasers is enhanced, and airplane tickets can be purchased at a lower price.

The chartered flight swapping business model is not only applicable to swapping tour groups traveling abroad, but also to a business for newly or additionally opening a specific air route and selling airplane seats when a direct air route to a region desired by airplane users is not opened due to imbalanced income or the like of the airline companies or when airplane seats are not enough in a high travel season. For example, since there is no direct air route between Incheon and Athens, it is inconvenient in that a via route should be used although there are tour and flight demands in Korea for Greece and the Mediterranean. However, if the chartered flight swapping business model employed in the present invention is implemented as a chartered airplane reservation system on-line, a new direct air route may be opened to flexibly meet flight demands, and thus convenience of airplane users may be enhanced, and the airplane users may purchase airplane tickets at a further lower price. Furthermore, the chartered flight swapping business model employed in the present invention may be applied to a system for reserving special chartered airplanes that are increased in number and operated when an international conference or event of a large scale is held abroad.

In order to implement the aforementioned chartered flight swapping business model as a chartered airplane reservation system on-line, the present invention is configured as follows.

A passenger swapping reservation system using a chartered transportation means of the present invention is a passenger swapping reservation system including a reservation server connected to a plurality of clients through an on-line network, wherein when storing reservation information on a chartered transportation means newly or additionally opened and operated to meet traffic demands between one and another regions, the reservation server stores passenger swapping information such as an origin, destination, departure date, and arrival date of a chartered transportation means traveling from one region to another region and passenger swapping information such as an origin, destination, departure date, and arrival date of the chartered transportation means returning from the other region to the one region, and the reservation server provides the passenger swapping information to the clients through the on-line network; one of the clients connects to the reservation server through the on-line network, reads the passenger swapping information provided by the reservation server, selects a specific origin, specific destination, specific departure date, and specific arrival date of the chartered transportation means traveling from the one region to the other region among the passenger swapping information, makes a reservation for the chartered transportation means, and records the selection and reservation information in the reservation server; and another of the clients connects to the reservation server through the on-line network, reads the passenger swapping information provided by the reservation server, selects a specific origin, specific destination, specific departure date, and specific arrival date of the chartered transportation means returning from the other region to the one region among the passenger swapping information, makes a reservation for the chartered transportation means, and records the selection and reservation information in the reservation server.

In a preferred embodiment of the present invention, the passenger swapping reservation system using a chartered transportation means comprises a plurality of inter-connected reservation servers connected to each other and connected to a plurality of clients through an on-line network, wherein the plurality of reservation servers comprise a manager reservation server for storing the passenger swapping information such as the origin, destination, departure date, and arrival date of the chartered transportation means traveling from the one region to the other region and the passenger swapping information such as the origin, destination, departure date, and arrival date of the chartered transportation means returning from the other region to the one region, and providing the passenger swapping information to the clients through the on-line network; and an agent reservation server connected to the manager reservation server, receiving and storing the passenger swapping information stored in the manager reservation server, and providing the received and stored passenger swapping information to the clients through the on-line network.

Preferably, when the agent reservation server fails to store the passenger swapping information transmitted from the manager reservation server to the agent reservation server, the agent reservation server may notify the manager reservation server of the failure through the on-line network; and after confirming integrity of the passenger swapping information or existence or not of an error, the manager reservation server may notify the agent reservation server of an error list related to the registration of the passenger swapping information.

More preferably, the client selectively connects to the manager reservation server or the agent reservation server, reads the passenger swapping information provided by the manager reservation server or the agent reservation server, selects the specific origin, specific destination, specific departure date, and specific arrival date of the chartered transportation means traveling from the one region to the other region or returning from the other region to the one region among the passenger swapping information, makes a reservation for the chartered transportation means, and records the selection and reservation information in the manager reservation server or the agent reservation server.

In addition, a passenger swapping reservation method using a chartered transportation means according to the present invention, which comprises the steps of storing reservation information on a chartered transportation means newly or additionally opened and operated to meet traffic demands between one and another regions in a chartered transportation means reservation server, wherein the reservation server stores passenger swapping information such as an origin, destination, departure date, and arrival date of the chartered transportation means traveling from one region to another region and passenger swapping information such as an origin, destination, departure date, and arrival date of the chartered transportation means returning from the other region to the one region; providing the passenger swapping information through an on-line network; reading, by clients connected to the reservation server through the on-line network, the passenger swapping information provided by the reservation server; selecting, by one of the clients connected to the reservation server, a specific origin, specific destination, specific departure date, and specific arrival date of the chartered transportation means traveling from the one region to the other region among the passenger swapping information, making a reservation for the chartered transportation means, and recording the selection and reservation information in the reservation server; and selecting, by another of the clients connected to the reservation server, the specific origin, specific destination, specific departure date, and specific arrival date of the chartered transportation means returning from the other region to the one region among the passenger swapping information, making a reservation for the chartered transportation means, and recording the selection and reservation information in the reservation server.

The step of making a reservation may include the step of selecting a seat class and seat number of the chartered transportation means and reserving the seat.

The passenger swapping information may include conditions for informing the clients of cancellation of a traveling of the chartered transportation means when a seat reservation rate of the chartered transportation means is lower than a certain rate until predetermined days before a date of departure from one region to another region.

For example, regarding a seat reservation rate of a chartered passenger swapping airplane between “Incheon-Narita” and “Narita-Incheon” during the Chuseok holidays, which is a high travel season in Korea, if the seat reservation rate of the chartered passenger swapping airplane of the “Narita-Incheon” route, i.e., the return route of the chartered passenger swapping airplane, is less than 60% although all seats of the “Incheon-Narita” route are reserved (the reservation rate is 100%) two months before the departure date, the reservation server cancels the chartered flight swapping program and notifies the clients that reserved the airplane of reservation cancellation information. Contrarily, if the seat reservation rate is more than 60%, the reservation server determines that the chartered flight swapping program is in progress and notifies the clients that reserved the airplane of reservation confirmation information.

In a preferred embodiment of the present invention, the method may further comprise the step of storing at least a piece of information among a plurality of pieces of tour product information including accommodations, restaurants, transportation means, tour courses, and tour guides of the one or other region in the reservation server, in addition to the passenger swapping information.

The tour product information may include types and classes of accommodations, restaurants, transportation means, tour courses, and tour guides. The plurality of pieces of the tour product information are simultaneously or sequentially provided and selected by the client located at the one or other region through the on-line network after the step of making a reservation for the chartered transportation means. At this time, if the client selects some pieces of the tour product information, the total amount of corresponding tour products related to the selected pieces of tour product information is preferably displayed.

The step of storing at least a piece of information among a plurality of pieces of tour product information may be performed by the client connected to the on-line network. In this case, the client that connects to the on-line network and stores the tour product information in the reservation server is preferably a vendor that provides tour products associated with the passenger swapping information of the chartered transportation means.

On the other hand, in an embodiment of the present invention, the client may be a general airplane ticket purchase demander or a travel agency that purchases airplane tickets in a large quantity.

In a preferred embodiment of the present invention, the reservation server may comprise a plurality of reservation servers connected to the clients through the on-line network, and the plurality of reservation servers may be connected to one another through the on-line network in a socket method and cooperatively store the passenger swapping information in real-time. For example, if the passenger swapping information such as the origin, destination, departure date, and arrival date of the chartered transportation means traveling from the one region to the other region and returning from the other region to the one region is stored in one of the plurality of reservation servers, the passenger swapping information is preferably transmitted and stored in the other reservation servers.

In a preferred embodiment of the present invention described above, if one of the clients located in the one region is connected to the one of the plurality of reservation servers through the on-line network, and the other clients located in the other regions are connected to the other reservation servers through the on-line network, whereby it is possible to prevent a traffic problem that occurs when a plurality of clients connects to the reservation server.

In another embodiment of the present invention, the passenger swapping reservation method may further comprise the step of, by the client, performing a member registration procedure provided by the reservation server in order to connect to the reservation server through the on-line network. The member registration procedure may include a procedure for recording personal information of the client, frequently visited destinations for a tour or business trip, scheduled dates of a vacation or business trip, contact information, and an e-mail address. In a further embodiment of the present invention, the passenger swapping reservation method may further comprise the step, by the reservation server, of transmitting the passenger swapping information to the client that has performed the member registration procedure through a cellular phone or e-mail. For example, in a case where the registered member is a general airplane ticket purchase demander, when passenger swapping information matching to a destination of a tour or business trip and to a scheduled date of a vacation or business trip recorded in the member registration procedure is stored in the reservation server, the passenger swapping information may be transmitted to a cellular phone or e-mail of the member. In a case where the registered member is a travel agency, all the passenger swapping information stored in the reservation server may be transmitted to a representative cellular phone or e-mail of the travel agency.

In the meantime, according to the present invention, although the transportation means may be an airplane or vessel, the present invention is not limited thereto, but may be applied to all types of transportation means that can carry passengers.

### Advantageous Effects

According to the present invention, it is possible to provide a reservation system and method, in which flight products and/or travel products can be efficiently and inexpensively reserved to meet international flight demands and/or travel demands.

Further, the present invention is advantageous in that limitation in reserving and operating flight routes previously opened by airline companies can be overcome, a direct air route is easily and inexpensively opened to flexibly meet flight demands, and travelers can make a reservation for the route. In addition, in the passenger swapping reservation system and method of the present invention, chartered international airplanes can be efficiently used for a variety of large-scaled international activities or events.

Furthermore, according to another embodiment of the present invention, it is possible to prevent a traffic problem that can occur when a plurality of clients simultaneously connects to a passenger swapping reservation server across the sea.

### BRIEF DESCRIPTION OF THE DRAWINGS

The above and other objects and features of the present invention will become apparent to those skilled in the art from the following descriptions of embodiments of the present invention given in conjunction with the accompanying drawings, in which:

FIG. 1 is a block diagram showing an embodiment of a passenger swapping reservation system using a chartered transportation means of the present invention.

FIG. 2 is a flowchart illustrating the step in which an operator of a reservation server newly registers or updates passenger swapping information of a chartered transportation means (departure date and time, arrival date and time, region, date, and the like) in the reservation server in an embodiment of the passenger swapping reservation method using a chartered transportation means of the present invention.

FIG. 3 is a flowchart illustrating the step in which a tour vendor that provides tour products in association with swapping airplane registration information registers tour product information including accommodations, restaurants, transportations, tour courses, tour guides and the like in the reservation server in the embodiment of the passenger swapping reservation method using a chartered transportation means of the present invention.

FIG. 4 is a flowchart illustrating the step in which a client such as a general airplane ticket purchase demander or a travel agency confirms swapping airplane registration information provided by the reservation server, makes a reservation for seats of a chartered airplane, and additionally purchases a tour product provided by a tour vendor in the embodiment of the passenger swapping reservation method using a chartered transportation means of the present invention.

FIG. 5 is a flowchart illustrating the step in which when an operator of a reservation server among a plurality of reservation servers registers or updates the swapping airplane registration information (departure date and time, arrival date and time, region, date, and the like) in any one of the plurality of reservation servers, the swapping airplane registration information is transmitted in real-time to other reservation servers to register or update the swapping airplane registration information in another embodiment of the passenger swapping reservation method using a chartered transportation means of the present invention.

### MODE FOR THE INVENTION

Hereinafter, the present invention will be described in detail with reference to the accompanying drawings that are not for limitation of the present invention but for illustrative purposes.

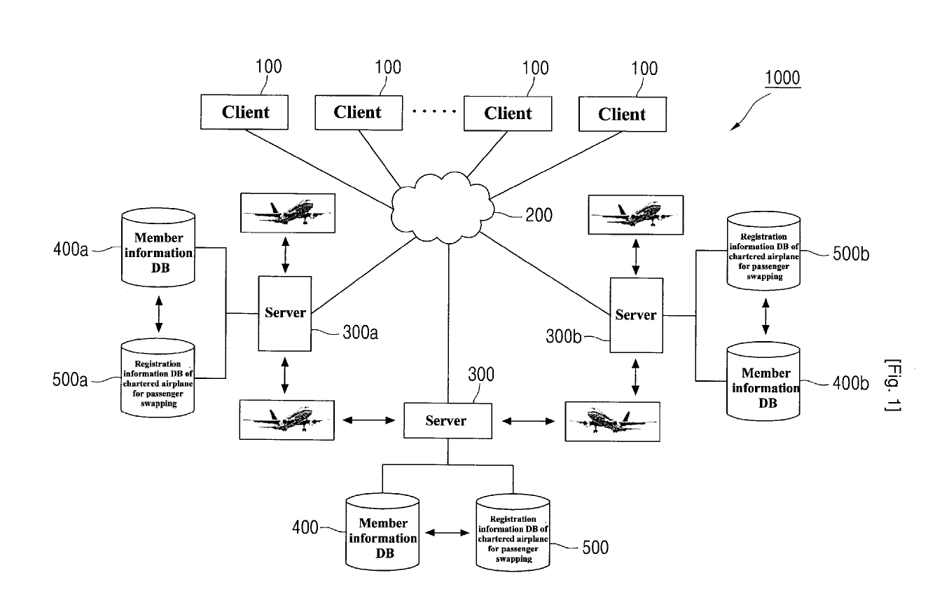

FIG. 1 is a block diagram showing an embodiment of a passenger swapping reservation system using a chartered transportation means of the present invention. Referring to FIG. 1, an embodiment of the system 1000 comprises a plurality of clients 100, a network 200, a plurality of reservation servers 300, 300a, and 300b connected to the clients and connected to one another in a socket method in real-time through the network, member information databases 400, 400a, and 400b respectively connected to the plurality of reservation servers, and registration information databases of chartered airplane for passenger swapping 500, 500a, and 500b. The client 100 is a user terminal or a personal computer (PC) capable of connecting to the reservation servers 300, 300a, and 300b, which operate a specific website, through the Internet. The client 100 is connected to the reservation servers 300, 300a, and 300b through the network 200, more specifically, through a public network such as an Internet leased line or a telephone line.

As shown in FIG. 1, in the preferable embodiment of the present invention, a client located at a region (e.g., Korea) connects to a Korean company's manager reservation server 300 operating a chartered flight swapping program through an on-line network, and another client located at another region (e.g., Germany) connects to a German agent reservation server 300a or 300b of the chartered flight swapping program through the on-line network. If the reservation system 1000 is configured in this manner, it is possible to prevent a traffic problem that may occur when a plurality of clients 100 simultaneously connects to the Korean company's manager reservation server 300 across the sea.

The Korean company's manager reservation server 300 provides the client 100 with an interactive screen through a web browser connected through the Internet, and a certain menu or the like is displayed on the interactive screen. If the client 100 selects a menu and inputs data, member information of the client 100 is transmitted to the server 300 via the network 200, and the transmitted member information is stored in the member information database 400 connected to the reservation server 300. The client connected to the German agent reservation server 300a or 300b also selects a menu and inputs data in the same web environment, and member information of the client is stored in the member information database 400a or 400b connected to the reservation server 300a or 300b.

Also, an operator of the Korean company's manager reservation server 300 stores reservation information of a chartered transportation means flying between Korea and Germany (e.g., Incheon and Frankfurt) in the reservation server 300. The operator newly registers or updates and stores swapping airplane registration information of a route from Incheon to Frankfurt, such as a departure date and time, arrival date and time, and the like, and swapping airplane registration information of a returning route of the chartered airplane from Frankfurt to Incheon, such as a departure date and time, arrival date and time, and the like, in the registration information database 500, and then provides the client 100 with the swapping airplane registration information in a web environment.

Then, the swapping airplane registration information newly registered or updated in the registration information database 500 of the Korean company's manager reservation server 300 is transmitted in real-time to the German agent reservation server 300a or 300b connected to the Korean company's manager reservation server 300 through the on-line network in a socket method. Accordingly, the German agent reservation server 300a or 300b newly registers or updates and stores the transmitted swapping airplane registration information in the registration information databases 500a or 500b and then provides the client 100 with the swapping airplane registration information in a web environment. When registration or update of the transmitted swapping airplane registration information is failed, the German agent reservation server 300a or 300b notifies the Korean company's manager reservation server 300 of the failure through the on-line network, and the Korean company's manager reservation server 300 confirms existence or not of an error value related to the registration or update of the swapping airplane registration information and then notifies the German agent reservation server 300a or 300b of an error list related to the registration or update of the swapping airplane registration information.

If the client 100 that has completed a membership joining procedure connects to a reservation server 300, 300a, or 300b covering its region in a web environment, selects its desired information among the swapping airplane registration information (e.g., Incheon to Frankfurt, departure at 09:00 Oct. 1, 2007 and arrival at 12:00⇄Frankfurt to Incheon, departure at 15:00 Oct. 1, 2007 and arrival at 10:00 Oct. 2, 2007) through an interactive menu, and makes a reservation, the related reservation information is stored in the respective registration information databases 500, 500a, and 500b in the form of a table associated with a data table of the swapping airplane registration information.

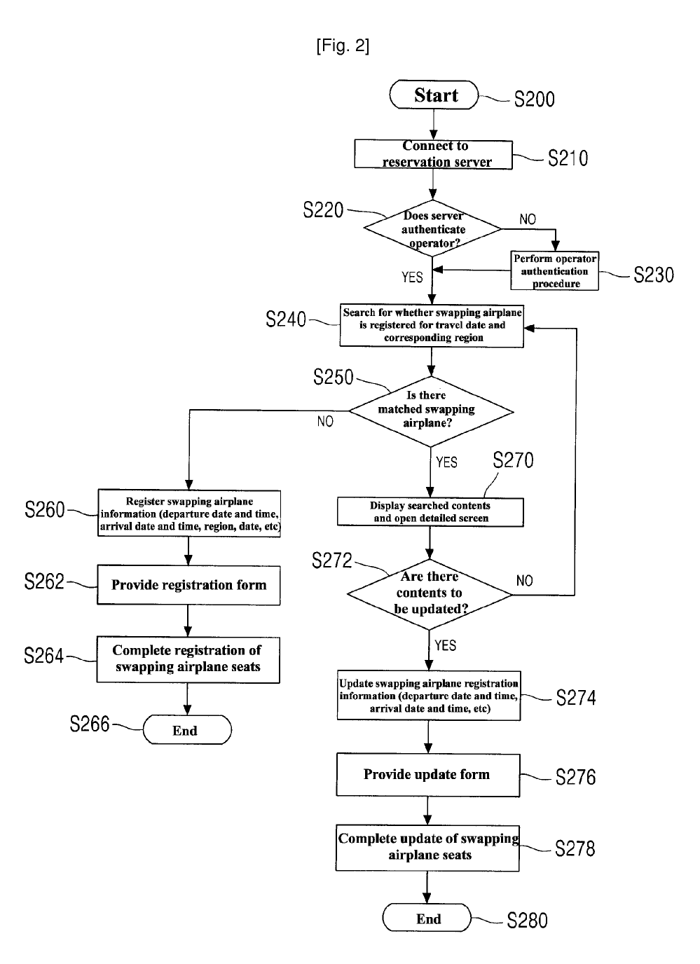

Each step of the embodiment of the passenger swapping reservation method using a chartered transportation means of the present invention will be described below in detail with reference to FIGS. 2 to 4.

FIG. 2 is a flowchart illustrating the step in which an operator of the reservation server newly registers or updates swapping airplane registration information (departure date and time, arrival date and time, region, date, and the like) in a reservation server.

First, as shown in FIG. 2, if an operator of the reservation server 300 starts a procedure for newly registering or updating swapping airplane registration information (step S200), the operator connects to the reservation server 300 (step S210), and the reservation server 300 inquires whether the connected person is an authenticated operator (step S220). If the operator inputs identification (ID) and a password in response to the inquiry and succeeds in the authentication, the process proceeds to the next step S240. If the authentication is failed, an operator authentication procedure is performed (step S230). In the operator authentication procedure, personal information, i.e., a name and a residence registration number, of the connected operator is inputted and confirmed, and the reservation server 300 confirms the personal information from an operator data table of the member information database 400 connected to the reservation server 300.

If the operator is confirmed to be authorized as a result of the confirmation, the process proceeds to step S240, and the operator searches for whether a chartered passenger swapping airplane (hereinafter, referred to as a swapping airplane) is registered for a travel date and a corresponding region appropriate to a chartered flight swapping program from the registration information database 500 through a menu screen provided by the reservation server 300 (step S240). For example, it is confirmed whether swapping airplanes matching to popular routes of “Incheon-Frankfurt”, “Incheon-Melbourne”, “Incheon-Paris”, “Incheon-London”, “Incheon-Bangkok”, “Incheon-Tokyo”, and the like are registered for September 2007, in which Chuseok holidays are included (step S250).

If there is no swapping airplane in the “Incheon-Tokyo” route as a result of the confirmation, swapping airplane information (departure date and time, arrival date and time, origin, and destination) of the “Incheon-Tokyo” route is recorded in the registration information database 500 (step S260). At this time, the departure date and time, arrival date and time, origin, destination, and the like of the “Tokyo-Incheon” route for swapping passengers of the swapping airplane of the “Incheon-Tokyo” route are also recorded in the registration information database 500. A registration form for registering the departure date and time, arrival date and time, origin, destination, and the like of the swapping airplane is provided on an interactive screen by the reservation server 300 (step S262). When the operator completes registration of the seats of the swapping airplane (step S264), the procedure of registering swapping airplane information of the operator is ended (step S266).

On the other hand, if it is confirmed in step S250 that a swapping airplane matching to the “Incheon-Tokyo” route is registered in the registration information database 500 and then the corresponding swapping airplane is selected through the interactive menu provided by the reservation server 300, the contents searched from the reservation server 300 are displayed and detailed records of the registration information database 500 are open on the screen (step S270). At this time, it is confirmed whether there are contents that need to be updated among the detailed records of the registration information database 500. If there are no contents that need to be updated, the process returns to step S240, and the steps thereafter are repeated. If there are contents that need to be updated, the swapping airplane information of the “Incheon-Tokyo” route, e.g., departure date and time, arrival date and time, seats, and the like, is updated, and the updated information is recorded in the registration information database 500 (step S274). At this time, the departure date and time, arrival date and time, seats, and the like of the “Tokyo-Incheon” route for swapping passengers of the swapping airplane of the “Incheon-Tokyo” route are also updated, and the updated information is recorded in the registration information database 500. An update form for updating the departure date and time, arrival date and time, seats, and the like of the swapping airplane is provided on an interactive screen by the reservation server 300 (step S276). If the operator completes update of the seats of the swapping airplane (step S278), the procedure of updating swapping airplane information of the operator is ended (step S280).

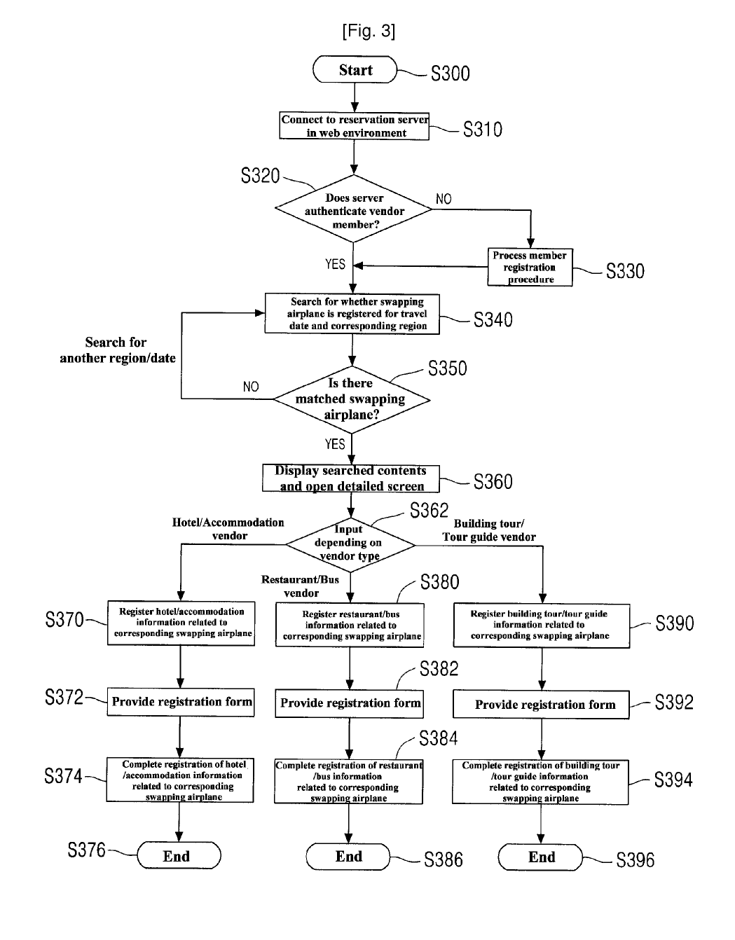

FIG. 3 is a flowchart illustrating the step in which a tour vendor that provides tour products in association with swapping airplane registration information registers tour product information in a reservation server.

First, as shown in FIG. 3, when a vendor, i.e., a client 100, starts a procedure for registering its tour product information in association with swapping airplane registration information (step S300), the client 100 connects to the reservation server 300 in a web environment (step S310), and the reservation server 300 authenticates whether the connected client is a member registered in the member information database 400 (step S320). If the client is a member, the client inputs an ID and a password. Then, if authentication is successful, the process proceeds to the next step S340. If the client is not a member, a membership joining procedure is performed (step S330). In the membership joining procedure, the reservation server 300 receives a member type (whether the client is a vendor member or a general user member) and personal information, i.e., name, address, contact information (cellular phone number, e-mail address, and phone number), and residence registration number (or a corporation registration number) from the connected client, through an interactive screen and stores the received information in the form of a vendor member information data table of the member information database 400 connected to the reservation server 300.

Next, the process proceeds to step S340, and the vendor searches for whether a chartered passenger swapping airplane (hereinafter, referred to as a swapping airplane) is registered for a travel date and a corresponding region appropriate to a chartered flight swapping program from the registration information database 500 through a menu screen provided by the reservation server 300 (step S340). For example, it is confirmed whether swapping airplanes matching to popular routes of “IncheonFrankfurt”, “Incheon-Melbourne”, “Incheon-Paris”, “Incheon-London”, “IncheonBangkok”, “Incheon-Tokyo”, and the like are registered for September 2007, in which Chuseok holidays are included (step S350).

When there is no swapping airplane for the routes as a result of the confirmation, the process returns to step S340 in order to search for whether there are swapping airplanes for other regions and dates (e.g., “Incheon-Osaka” in May 2007). If there are swapping airplanes for the routes and the vendor selects a swapping airplane of the “Incheon-Paris” route scheduled in September 2007, which shows the highest purchase rate among the routes, through an interactive screen provided by the reservation server 300, the contents searched from the reservation server 300 are displayed and detailed records of the registration information database 500 are open on the screen (step S360). At this time, if the member connected to the reservation server 300 is a vendor member, the reservation server 300 opens detailed records on the screen and provides an interactive menu for inputting tour products of the vendor depending on the type of the vendor member (step S362).

If the vendor is a hotel/accommodation vendor, the vendor registers hotel/accommodation information related to a corresponding swapping airplane in the registration information database 500 (step S370). When the reservation server 300 provides a registration form via an interactive screen (step 5372) and the vendor completes registration of the hotel/accommodation information related to the swapping airplane (step S374), the information is stored in the form of a vendor tour product information table associated with the table of the swapping airplane registration information stored in the registration information database 500, and the procedure is ended (step S376). If the vendor is a restaurant/bus vendor, the vendor registers restaurant/bus information related to a corresponding swapping airplane in the registration information database 500 (step S380). When the reservation server 300 provides a registration form via an interactive screen (step 5382) and the vendor completes registration of the restaurant/bus information related to the swapping airplane (step 384), the information is stored in the form of a vendor tour product information table associated with the table of the swapping airplane registration information stored in the registration information database 500, and the procedure is ended (step S386). Next, if the vendor is a building tour/tour guide vendor, the vendor registers building tour/tour guide information related to a corresponding swapping airplane in the registration information database 500 (step S390). When the reservation server 300 provides a registration form via an interactive screen (step 5392) and the vendor completes registration of the building tour/tour guide information related to the swapping airplane (step S394), the information is stored in the form of a vendor tour product information table associated with the table of the swapping airplane registration information stored in the registration information database 500, and the procedure is ended (step S396).

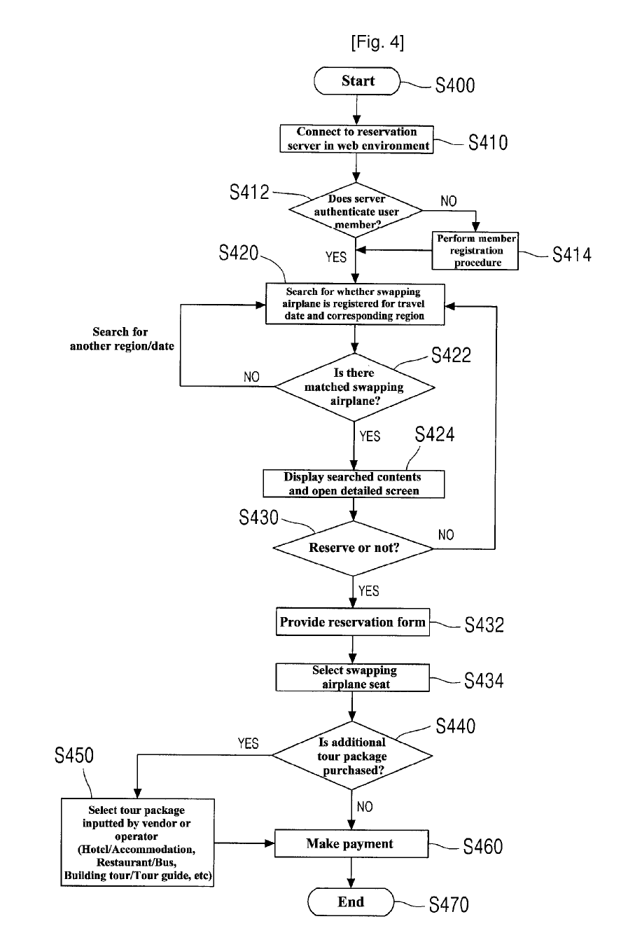

FIG. 4 is a flowchart illustrating the step in which a client 100 such as a general airplane ticket purchase demander or a travel agency makes a reservation for seats of a swapping airplane and additionally purchases a tour product provided by a tour vendor.

First, as shown in FIG. 4, when a general airplane ticket purchase demander or travel agency, i.e., a client 100, starts a procedure for reserving seats of a swapping airplane (step S400), the client 100 connects to the reservation server 300 in a web environment (step S410), and the reservation server 300 authenticates whether the connected client is a member registered in the member information database 400 (step S412). If the client is a member, the client inputs an ID and a password. Then, if authentication is successful, the process proceeds to the next step S420. If the client is not a member, a membership joining procedure is performed (step S414). In the membership joining procedure, the reservation server 300 receives a member type (whether the client is a general airplane ticket purchase demander or a travel agency member) and personal information, i.e., name, address, contact information (cellular phone number, e-mail address, and phone number), and residence registration number (or a corporation registration number) from the connected client, through an interactive screen and stores the received information in the form of a user member information data table of the member information database 400 connected to the reservation server 300.

Next, the process proceeds to step S420, and the user searches for whether a chartered passenger swapping airplane (hereinafter, referred to as a swapping airplane) is registered for a desired travel date and a corresponding region from the registration information database 500 through a menu screen provided by the reservation server 300 (step S420). For example, it is confirmed whether swapping airplanes matching to popular routes of “Incheon-Frankfurt”, “Incheon-Melbourne”, “Incheon-Paris”, “Incheon-London”, “Incheon-Bangkok”, “Incheon-Tokyo”, and the like are registered for September 2007, in which Chuseok holidays are included (step S422).

When there is no swapping airplane for the routes as a result of the confirmation, the process returns to step S420 in order to search for whether there are swapping airplanes for other regions and dates (e.g., “Incheon-Osaka” in May 2007). If there is a swapping airplane desired by the user (e.g., “Incheon-Paris” route in September 2007) and the user selects the swapping airplane of the “Incheon-Paris” route scheduled in September 2007 through an interactive screen provided by the reservation server 300, the contents searched from the reservation server 300 are displayed and detailed records of the registration information database 500 are open on the screen (step S424). At this time, if the detailed records are open on the screen, whether or not the user will reserve the swapping airplane is queried (step S430). If the user selects “Do not reserve” in response to the query, the process returns to step S420, and the steps thereafter are repeated. If the user selects “Reserve”, a reservation form via an interactive screen is provided by the reservation server 300 (step S432). If the user selects a desired seat class and seat number, the procedure of selecting a seat of the swapping airplane is ended (step S434).

Thereafter, the reservation server 300 reads data from the tour product information table associated with the table of the swapping airplane registration information stored in the registration information database 500 and provides the read data to the user as an interactive menu to query whether to purchase an additional tour package (step S440). If the user selects “Do not purchase additional tour package”, a menu related to payment is displayed on the screen. If the user selects an item of payment means such as a credit card payment, telebanking, Internet banking, mobile banking, cellular phone payment, or the like and pays a deposit or all the airplane fare (step S460), the procedure of making a reservation is ended (step S470).

On the other hand, if the user selects “Purchase additional tour package” in step S440, the user may select a tour package such as a hotel/accommodation, restaurant/bus, building tour/tour guide, and the like from an interactive menu provided by the tour product information table inputted by a vendor or an operator and stored in the registration information database 500 (step S450). Products of these tour packages may be simultaneously or sequentially provided to users, for example, in Korea, France, Germany, and the like, and a user may select and reserve the products. For example, if types and classes of hotels are provided as an interactive menu, and the user selects a type and class of a hotel, an amount including the swapping airplane fare and the room rate of the hotel is displayed on the screen, and additionally, an interactive menu for selecting a type and class of meals is provided. If the user selects a type and class of meals through the interactive menu, an amount including the swapping airplane fare, the room rate of the hotel, and meal expenses is display on the screen, and whether or not the user selects the tour package is inquired. If the user selects “No”, the process returns to the initial menu for selecting a tour package. If the user selects “Yes”, the user is inquired whether to make a payment. If the user selects payment, a menu related to the payment is displayed on the screen. If the user selects an item of payment means such as a credit card payment, telebanking, Internet banking, mobile banking, cellular phone payment, or the like and pays a deposit or all the package fee (step S460), the procedure of making a reservation is ended (step S470).

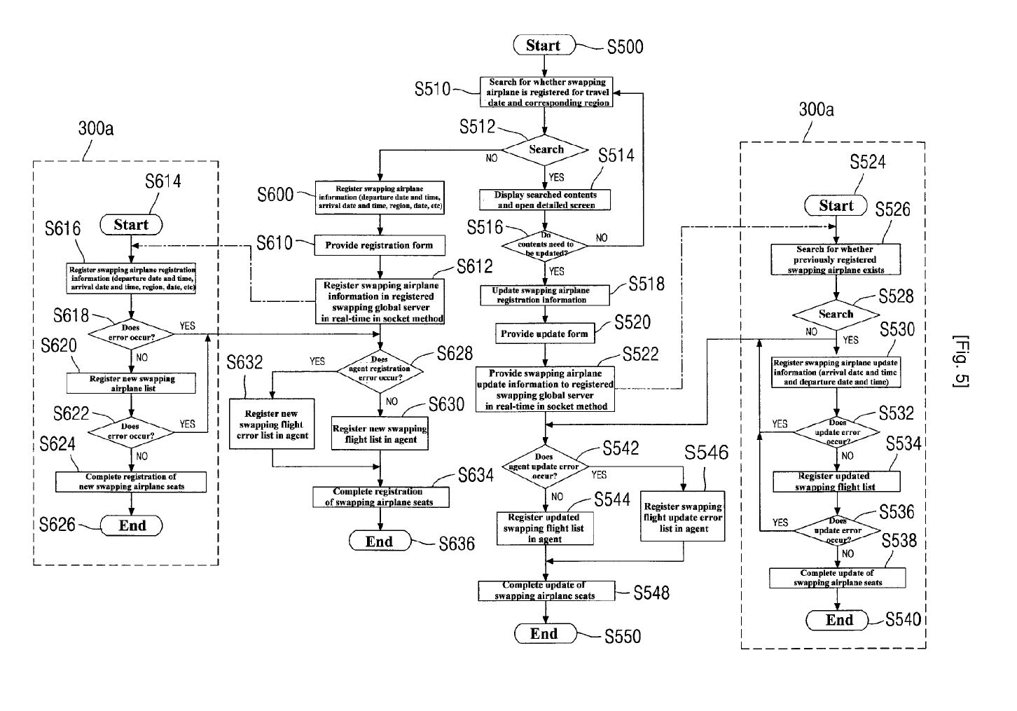

FIG. 5 is a flowchart illustrating the step in which an operator of the reservation server newly registers or updates swapping airplane registration information (departure date and time, arrival date and time, region, date, and the like) in a reservation server in another embodiment of the present invention.

A plurality of reservation servers is provided in the other embodiment of the present invention. The other embodiment is almost the same as the embodiment shown in FIGS. 2 to 4 except that when swapping airplane registration information is registered or updated in the manager reservation server among the plurality of reservation servers, the swapping airplane registration information is transmitted to and registered or updated in agent reservation servers in real-time. Accordingly, in relation to the other embodiment of the present invention, only the step of registering and updating swapping airplane information performed by the operator as shown in FIG. 5 will be described. Therefore, in describing the other embodiment of the present invention, the step of registering tour products by vendors and the step of making a reservation by users will be omitted since most of these steps are similar to those of the previous embodiment of the present invention.

Also, in the other embodiment of the present invention shown in FIG. 5, the step of connecting to a reservation server (step S210), the step of authenticating an operator by the reservation server (step S220), and the step of proceeding a procedure for authenticating the operator (step 5230) as shown in FIG. 2 will be omitted for convenience of explanation. However, those skilled in the art will easily understand that such steps may also be included in the other embodiment of FIG. 5.

First, as shown in FIG. 5, if a Korean operator starts the step of registering and updating swapping airplanes (step S500), the Korean operator searches for whether a chartered passenger swapping airplane (hereinafter, referred to as a swapping airplane) is registered for a travel date and corresponding region appropriate to a chartered flight swapping program from the registration information database 500 through a menu screen provided by the manager reservation server 300 (step S510). For example, it is searched whether swapping airplanes matching to popular routes of “IncheonFrankfurt”, “Incheon-Melbourne”, “Incheon-Paris”, “Incheon-London”, “IncheonBangkok”, “Incheon-Tokyo”, and the like are registered for September 2007, in which Chuseok holidays are included (step S512).

If there is no swapping airplane in the “Incheon-Frankfurt” route as a result of the search, swapping airplane information (departure date and time, arrival date and time, origin, destination, and the like) of the “Incheon-Frankfurt” route is recorded in the registration information database 500 (step S600). At this time, the departure date and time, arrival date and time, origin, destination, and the like of the “Frankfurt-Incheon” route for swapping passengers of the swapping airplane of the “Incheon-Frankfurt” route are also recorded in the registration information database 500. A registration form for registering the departure date and time, arrival date and time, origin, destination, and the like of the swapping airplane is provided on an interactive screen by the manager reservation server 300 (step S610).

In the other embodiment of the present invention, when the operator of the Korean manager reservation server 300 stores information on a swapping airplane flying between Korea and Germany (e.g., “Incheon-Frankfurt”) in the reservation server 300 (step S612), the German agent reservation server 300a connected in real-time to the Korean manager reservation server 300 in a socket method through the on-line network 200 is allowed to start a procedure for registering the swapping airplane information (step S614). Accordingly, the swapping airplane information newly registered in the registration information database 500 of the Korean manager reservation server 300 is transmitted to the German agent reservation server 300a. At this time, an agent that manages the German agent reservation server 300a may view the transmitted swapping airplane information through a screen in a web environment and then performs a procedure for registering the transmitted swapping airplane information (step S616). At this time, if an error occurs in the agent reservation server 300a, the manager reservation server 300 is notified of an error value through the on-line network 200 (step S618). If there is no error, the swapping airplane information is registered in a list to include a new swapping airplane (step S620). If an error occurs in the agent reservation server 300a in this step, the manager reservation server 300 is notified of an error value through the on-line network 200 (step S622). If there is no error, registration of swapping airplane seats is completed (step S624), and the procedure is ended (step S626).

In the meantime, the Korean manager reservation server 300 confirms whether it is notified of an error value from the German agent reservation server 300a (step S628). If there is no registration error in the agent reservation server 300a, the manager reservation server allows the agent reservation server 300a to register the swapping airplane information in a list to include a new swapping airplane (step S630). Then, registration of swapping airplane seats is completed (step S634), and the procedure is ended (step S636). If a registration error occurs in the agent reservation server 300a, the manager reservation server allows the agent reservation server 300a to register the swapping airplane information in a list to include a registration error of a new swapping airplane, and directs the agent reservation server 300a to take an action for the registration of new swapping airplane information (step S632). Then, based on the action taken by the agent reservation server 300a, registration of swapping airplane seats is completed (step S634), and the procedure is ended (step S636).

Next, if it is confirmed in step 5512 that a swapping airplane matching to the “Incheon-Frankfurt” route is registered in the registration information database 500, and then the corresponding swapping airplane is selected through an interactive menu of the reservation server 300, the contents searched from the reservation server 300 are displayed, and detailed records of the registration information database 500 are open on the screen (step S514). At this time, it is confirmed whether there are contents that need to be updated among the detailed records of the registration information database 500. If there are no contents that need to be updated, the process returns to step 5510, and the steps thereafter are repeated. If there are contents that need to be updated, the swapping airplane information of the “Incheon-Frankfurt” route, e.g., departure date and time, arrival date and time, seats, and the like, is updated, and the updated information is recorded in the registration information database 500 (step S518). An update registration form for updating the departure date and time, arrival date and time, seats, and the like of the swapping airplane is provided on an interactive screen by the Korean manager reservation server 300 (step S520).

In the other embodiment of the present invention, when the operator of the Korean manager reservation server 300 stores updates of information on a swapping airplane flying between Korea and Germany (e.g., “Incheon-Frankfurt”) in the reservation server 300 (step S522), the German agent reservation server 300a connected in real-time to the Korean manager reservation server 300 in a socket method through the online network 200 is allowed to start a procedure for updating the swapping airplane information (step S524). Accordingly, the swapping airplane information updated and registered in the registration information database 500 of the Korean manager reservation server 300 is transmitted in real-time. At this time, the German agent reservation server 300a searches for whether a swapping airplane corresponding to the transmitted update information is registered in the agent reservation server 300a (step S526). If corresponding swapping airplane information is not registered as a result of the search (step S528), the agent reservation server 300a notifies the manager reservation server 300 of an error value through the on-line network 200. If corresponding swapping airplane information is registered, the agent reservation server performs a procedure for registering the corresponding swapping airplane update information (departure date and time, arrival date and time, and seats) (step S530). At this time, if an update error occurs in the agent reservation server 300a, the manager reservation server 300 is notified of an error value through the on-line network 200 (step S532). If there is no update error, the updated swapping airplane information is registered in a list to include an updated swapping airplane (step S534). In such a case, if an update error occurs in the agent reservation server 300a, the manager reservation server 300 is notified of an error value through the on-line network 200 (step S536). If there is no update error, update registration of swapping airplane seats is completed (step S538), and the procedure is ended (step S540).

Meantime, the Korean manager reservation server 300 confirms whether it is notified of an error value from the German agent reservation server 300a (step S542). If there is no update registration error in the agent reservation server 300a, the manager reservation server allows the agent reservation server 300a to register the swapping airplane information in a list to include an updated swapping airplane (step S544). Then, update registration of swapping airplane seats is completed (step S548), and the procedure is ended (step S550). If an update registration error occurs in the agent reservation server 300a, the manager reservation server allows the agent reservation server 300a to register the swapping airplane information in a list to include an update registration error of a swapping airplane, and directs the agent reservation server 300a to take an action for the registration of updated swapping airplane information (step S546). Then, based on the action taken by the agent reservation server 300a, update registration of swapping airplane seats is completed (step S548), and the procedure is ended (step S550).

According to the other embodiment of the present invention, it is possible to prevent a traffic problem that can occur when a plurality of clients 100 simultaneously connects to the Korean company's manager reservation server 300 across the sea.

Although the present invention has been described in connection with the accompanying drawings and the aforementioned embodiments, the present invention is not limited to the accompanying drawings and the disclosed embodiments. It will be readily understood by those skilled in the art that various modifications and changes can be made thereto according to the purport of the present invention and the modifications and changes are included in the scope of the present invention.

1. A passenger swapping reservation system using a chartered transportation means, which includes a reservation server connected to a plurality of clients through an on-line network,
wherein when storing reservation information on a chartered transportation means newly or additionally opened and operated to meet traffic demands between one and another regions, the reservation server stores passenger swapping information such as an origin, destination, departure date, and arrival date of a chartered transportation means traveling from one region to another region and passenger swapping information such as an origin, destination, departure date, and arrival date of the chartered transportation means returning from the other region to the one region, and the reservation server provides the passenger swapping information to the clients through the on-line network;
one of the clients connects to the reservation server through the on-line network, reads the passenger swapping information provided by the reservation server, selects a specific origin, specific destination, specific departure date, and specific arrival date of the chartered transportation means traveling from the one region to the other region among the passenger swapping information, makes a reservation for the chartered transportation means, and records the selection and reservation information in the reservation server; and
another of the clients connects to the reservation server through the on-line network, reads the passenger swapping information provided by the reservation server, selects a specific origin, specific destination, specific departure date, and specific arrival date of the chartered transportation means returning from the other region to the one region among the passenger swapping information, makes a reservation for the chartered transportation means, and records the selection and reservation information in the reservation server.

2. The system as claimed in claim 1, wherein the reservation server comprises:
a manager reservation server for storing the passenger swapping information such as the origin, destination, departure date, and arrival date of the chartered transportation means traveling from the one region to the other region and the passenger swapping information such as the origin, destination, departure date, and arrival date of the chartered transportation means returning from the other region to the one region, and providing the passenger swapping information to the clients through the on-line network; and
an agent reservation server connected to the manager reservation server, receiving and storing the passenger swapping information stored in the manager reservation server, and providing the received and stored passenger swapping information to the clients through the on-line network,
wherein the servers are connected to one another through the on-line network.

3. The system as claimed in claim 2, wherein when the agent reservation server fails to store the passenger swapping information transmitted from the manager reservation server to the agent reservation server, the agent reservation server notifies the manager reservation server of the failure through the on-line network; and after confirming integrity of the passenger swapping information or existence or not of an error, the manager reservation server notifies the agent reservation server of an error listed related to the registration of the passenger swapping information.

4. The system as claimed in claim 2, wherein the client selectively connects to the manager reservation server or the agent reservation server, reads the passenger swapping information provided by the manager reservation server or the agent reservation server, selects the specific origin, specific destination, specific departure date, and specific arrival date of the chartered transportation means traveling from the one region to the other region or returning from the other region to the one region among the passenger swapping information, makes a reservation for the chartered transportation means, and records the selection and reservation information in the manager reservation server or the agent reservation server.

5. A passenger swapping reservation method using a chartered transportation means, comprising the steps of:
storing reservation information on a chartered transportation means newly or additionally opened and operated to meet traffic demands between one and another regions in a chartered transportation means reservation server, wherein the reservation server stores passenger swapping information such as an origin, destination, departure date, and arrival date of the chartered transportation means traveling from one region to another region and passenger swapping information such as an origin, destination, departure date, and arrival date of the chartered transportation means returning from the other region to the one region;
providing the passenger swapping information through an on-line network;
reading, by clients connected to the reservation server through the on-line network, the passenger swapping information provided by the reservation server;
selecting, by one of the clients connected to the reservation server, a specific origin, specific destination, specific departure date, and specific arrival date of the chartered transportation means traveling from the one region to the other region among the passenger swapping information, making a reservation for the chartered transportation means, and recording the selection and reservation information in the reservation server; and
selecting, by another of the clients connected to the reservation server, the specific origin, specific destination, specific departure date, and specific arrival date of the chartered transportation means returning from the other region to the one region among the passenger swapping information, making a reservation for the chartered transportation means, and recording the selection and reservation information in the reservation server.

6. The method as claimed in claim 5, wherein the passenger swapping information includes conditions for informing the clients of cancellation of a traveling of the chartered transportation means when a seat reservation rate of the chartered transportation means is lower than a certain rate until predetermined days before a date of departure from one region to another region.

7. The method as claimed in claim 5, further comprising the step of storing at least a piece of information among a plurality of pieces of tour product information including accommodations, restaurants, transportation means, tour courses, and tour guides of the one or other region in the reservation server, in addition to the passenger swapping information.

8. The method as claimed in claim 7, wherein the plurality of pieces of the tour product information are simultaneously or sequentially provided and selected by the client located at the one or other region through the on-line network after the step of making a reservation for the chartered transportation means, and if the client selects some pieces of the tour product information, the total amount of corresponding tour products related to the selected pieces of tour product information is displayed.

9. The method as claimed in claim 7, wherein the step of storing at least a piece of information among a plurality of pieces of tour product information is performed by the client connected to the on-line network, and the client is a vendor that provides tour products associated with the passenger swapping information of the chartered transportation means.

10. The method as claimed in claim 5, wherein the reservation server comprises a plurality of reservation servers connected to the clients through the on-line network, and the plurality of reservation servers are connected to one another through the on-line network in a socket method and cooperatively stores the passenger swapping information in real-time.

11. The method as claimed in claim 10, wherein if the passenger swapping information such as the origin, destination, departure date, and arrival date of the chartered transportation means traveling from the one region to the other region and returning from the other region to the one region is stored in one of the plurality of reservation servers, the passenger swapping information is transmitted and stored in the other reservation servers.

12. The method as claimed in claim 11, wherein one of the clients located in the one region is connected to the one of the plurality of reservation servers through the on-line network, and the other clients located in the other regions are connected to the other reservation servers through the on-line network.

13. The method as claimed in claim 5, further comprising the step of, by the client, performing a member registration procedure provided by the reservation server to connect to the reservation server through the on-line network.

14. The method as claimed in claim 13, further comprising the step of, by the reservation server, transmitting the passenger swapping information to the client that has performed the member registration procedure though a cellular phase or e-mail.

15. The method as claimed in claim 14, wherein in a case where the member that has performed the member registration procedure is a general airplane ticket purchase demander, when passenger swapping information matching to a destination of a tour or business trip and a scheduled date of a vacation or business trip recorded in the member registration procedure is stored in the reservation server, the passenger swapping information is transmitted to a cellular phone or e-mail of the member; and
in a case where the member that has performed the member registration procedure is a travel agency, all the passenger swapping information stored in the reservation server is transmitted to a representative cellular phone or e-mail of the travel agency.

16. The system as claimed in claim 3, wherein the client selectively connects to the manager reservation server or the agent reservation server, reads the passenger swapping information provided by the manager reservation server or the agent reservation server, selects the specific origin, specific destination, specific departure date, and specific arrival date of the chartered transportation means traveling from the one region to the other region or returning from the other region to the one region among the passenger swapping information, makes a reservation for the chartered transportation means, and records the selection and reservation information in the manager reservation server or the agent reservation server.

17. The method as claimed in claim 6, further comprising the step of storing at least a piece of information among a plurality of pieces of tour product information including accommodations, restaurants, transportation means, tour courses, and tour guides of the one or other region in the reservation server, in addition to the passenger swapping information.

18. The method as claimed in claim 6, wherein the reservation server comprises a plurality of reservation servers connected to the clients through the on-line network, and the plurality of reservation servers are connected to one another through the on-line network in a socket method and cooperatively stores the passenger swapping information in real-time.

19. The method as claimed in claim 6, further comprising the step of, by the client, performing a member registration procedure provided by the reservation server to connect to the reservation server through the on-line network.
